(19) United States
(12) Patent Application Publication
(10) Pub. No.: US 2008/0205659 A1
(43) Pub. Date: Aug. 28, 2008

(54) Method for improving spatial perception and corresponding hearing apparatus

(75) Inventors: Eghart Fischer, Schwabach (DE); Robert Kasanmascheff, Hochstadt (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 12/070,880

(22) Filed: Feb. 21, 2008

(30) Foreign Application Priority Data
Feb. 22, 2007 (DE) 102007008738.3

(51) Int. Cl. H04R 25/00

(52) U.S. Cl. 381/23.1

(57) ABSTRACT

In order to improve spatial perception of acoustic signals an input signal is received via aid of a binaural hearing apparatus and optionally analyzed. At least one variable that influences spatial perception of the binaural output signal, based on the input signal, of the hearing apparatus will be changed. Thus, for example, the distance or direction of a source at/from which it is perceived can, with the aid of a classifier or directional microphone, be varied automatically for corresponding input signals, as a result of which improved spatial perception can be achieved.

### CROSS REFERENCE TO RELATED APPLICATIONS

This application claims priority of German application No. 102007008738.3 DE filed Feb. 22, 2007, which is incorporated by reference herein in its entirety.

### FIELD OF INVENTION

The present invention relates to a method for the binaural supply of a human hearing with the aid of a binaural hearing apparatus. Furthermore, the present invention relates to a corresponding hearing apparatus for binaural supply. Here, a hearing apparatus is defined as being in particular one or more hearing devices and a headset or headphone.

### BACKGROUND OF INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including conch hearing devices or channel hearing devices (CIC), are provided. The hearing devices given as examples are worn on the outer ear or in the auditory canal. Furthermore, bone conduction hearing aids, implantable or vibrotactile hearing aids are also available on the market. With such devices the damaged hearing is either stimulated mechanically or electrically.

The essential components of the hearing devices are basically an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or more microphones 2 for picking up the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Natural spatial sound is altered and spatial perception diminished by traditional hearing-device signal processing and the acoustics in hearing devices. The sound quality suffers as a result. The perception of interfering noise is also affected by this. For the brain finds it easier to separate sources which are perceived spatially differently.

The aspects of spatial perception in hearing devices are scarcely discussed nowadays. It is merely known that directional microphones have an effect on the spatial transmission function and adversely affect the quality of the signal in terms of natural perception. Consequently, reducing the effect of a directional microphone can bring about an improvement in spatial perception, but this runs directly contrary to the purpose of using a directional microphone.

The article by Jörn Anemüiller: “Blind source separation as preprocessing for robust speech recognition”, in DEGA 2000, Oldenburg, describes how “blind source separation” can contribute to improved speech recognition. Here, a mixed signal from a useful source and an interfering source is picked up with several microphones. By means of appropriate filtering, the signals of the individual sources can then be separated.

Furthermore, from printed publication DE 103 51 509 A1 a method for adapting a hearing device taking the position of the head into consideration is known. The starting point is that a “blind source separation” is used in order to separate the signals from spatially distributed sources. In a hearing device, however, this requires a certain adaptation time, which, with each movement, would have to be passed through afresh. In order to avoid this, a position determining device is provided for determining the current position of the head of the wearer of the hearing device so that, based upon the position of the head, the relative change in acoustic source positions can rapidly be taken into account in a processing unit.

### SUMMARY OF INVENTION

The object of the present invention is consequently to propose a method and a corresponding hearing apparatus by means of which improved spatial perception is possible.

This object is achieved according to the invention in a method for the binaural supply of a human hearing with the aid of a binaural hearing apparatus through the picking up of an input signal of the hearing apparatus, processing of the input signal into an output signal, which leads to a spatial perception, and controlling of at least one variable of the output signal, based on the input signal, of the hearing apparatus such that spatial perception is altered.

Furthermore, the invention provides a hearing apparatus for the binaural supply of a human hearing comprising a pick-up device for picking up an input signal of the hearing apparatus, a processing device for generating an output signal, based on the input signal, which leads to a spatial perception and a controller for controlling the processing device with regard to at least one variable of the output signal of the hearing apparatus in such a way that the spatial perception is altered.

It is consequently possible in an advantageous manner to restore or simulate parts of a “destroyed auditory spaciousness”. Through selective use of virtual spatial mapping, the brain can be assisted in separating various sources without these having to be suppressed. Rather, by introducing processing blocks into the signal path, for example, the spatial impression can be restored or desired spatial effects achieved.

Preferably, the input signal or signals is/are analyzed and/or classified, and the controlling is effected in accordance with the classification result. In this way, spatial perception can be influenced depending on certain types or categories of input signals.

The analyzing of the input signal or signals can also comprise a determining of the reverberance of the input signal. The controlling is then effected according to the reverberance. Thus the controlling can, for example, be effected depending on the acoustic situation of a space.

Furthermore, the analyzing can comprise a separation of sound sources, and the controlling can be effected according to the separated sound sources. Specifically, the separation can be effected by a directional microphone and/or a blind source separation algorithm. By this means, spatial reproduction can be controlled depending on defined useful sound sources or interfering sound sources.

The analyzing can also comprise the detection of interfering noise, and the controlling effected according to the proportion of interfering noise. In this way, spatial reproduction can, independently of specific sound sources, be influenced in a global manner depending on proportions of interfering noise.

During analysis, a level of the input signal can also be determined so that the controlling of spatial reproduction can be carried out depending on the level determined. In this way, a desired spatial perception can be achieved in a simple manner depending on the loudness.

According to a further embodiment, at least one signal fed externally e.g. via an audio shoe can be identified by the hearing apparatus optionally alongside a microphone signal, and the controlling effected in accordance with the signals identified. In this way, a different spatial impression than with normal microphone signals can be achieved by means of specific spatial reproduction, for example in the case of signals fed inductively in large auditoria or churches.

The variables influencing spatial perception can be a distance of a source from the hearing apparatus, a spatial direction of a source relative to a predetermined zero-degree direction of the hearing apparatus, a source location and/or a characteristic of the spatial reverberation. These parameters influence spatial reproduction substantially.

### BRIEF DESCRIPTION OF THE DRAWINGS

The present invention will be explained in detail with reference to the attached drawings, in which:

FIG. 1 shows the basic structure of a hearing device with its essential components;

FIG. 2 shows a block diagram of an inventive hearing device;

FIG. 3 shows a schematic diagram of an inventive hearing device comprising an FIR filter;

FIG. 4 shows a diagram of an FIR (finite impulse response) filter and

FIG. 5 shows forms of implementation of the processing block for spatial perception.

### DETAILED DESCRIPTION OF INVENTION

The exemplary embodiments described in more detail below represent preferred embodiments of the present invention.

The present invention is based upon the recognition that there are numerous characteristics of binaurally presented audio signals which influence spatial perception. Various methods are known from audio engineering which, where a stereo signal is present, influence these characteristics such that a desired perception is achieved. Target variables here include, among others:

the distance of the source(s) from the earphone; it influences inter alia the ratio between direct sound and reflections and the nature of the first wavefront.

the perceived stereo width; this corresponds to the spatial angle over which the sound sources are distributed.

the localization of the source(s); this corresponds to the precise determination of the location of a source from angle and distance.

the spatial reverberation characteristics; thus, quiet reverberation, for example, can be removed from the signal.

For the invention, it is not, however, absolutely essential for stereo signals to be present. Rather, the invention can also be applied to methods which simulate the head-related, spatial transmission function. The hearing devices can also receive exactly the same signals (e.g. monosignals).

The starting point for improving spatial reproduction is that, the algorithms present in a hearing device (e.g. removal of interfering noise) and the microphone positions can result in the sound perceived naturally being alienated. Furthermore, the sources can be perceived as being very close to the head or even in the head, which makes separation of the sources during hearing difficult. Specifically where directional microphones are used, an improvement in spatial reproduction may be necessary since, while a directional microphone makes it possible to mask out interfering signals, it generally also has a strongly adverse effect on auditory spaciousness perception.

For improved spatial reproduction, provision is therefore made according to the invention for including one or more signal processing blocks in the signal path, optionally also in different channels or spatial signal parts, which will influence one or more of the aforementioned target variables. The aim here is either to restore a natural sound pattern or to achieve certain virtual perceptions.

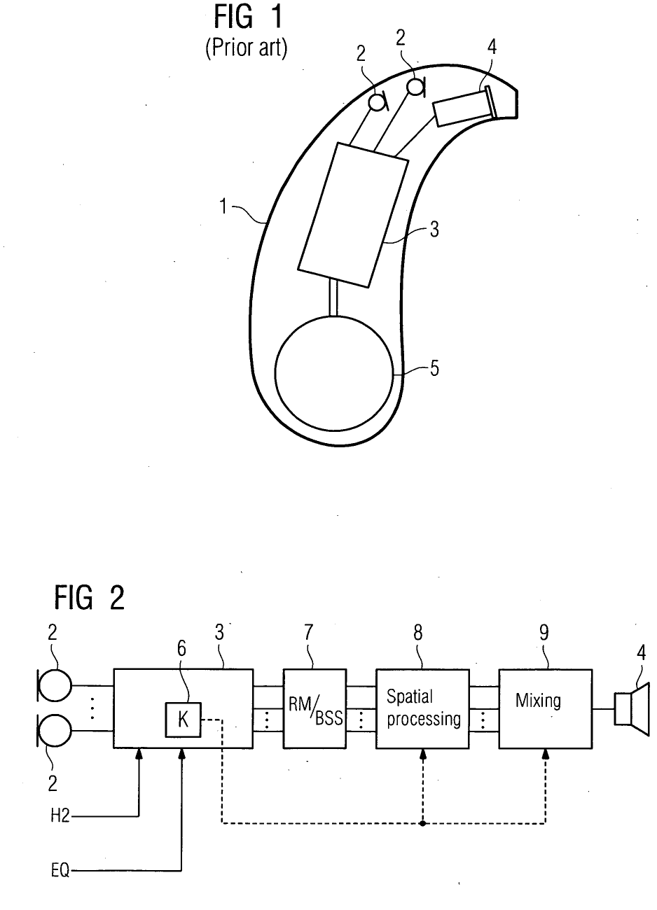

An example of a general design of a hearing device comprising such a signal processing block for improving spatial perception is reproduced schematically in FIG. 2. As in the example shown in FIG. 1, one or more microphones 2 are connected to a signal processing unit 3. Here, the latter serves in practice as a processing unit and controller. As an analyzing device, the processing unit 3 has a classifier 6, which provides a corresponding classification signal as an output signal. As well as the microphone input signals, the signal processing unit 3 can optionally have further inputs. Thus, for example, a signal H2 from a hearing device on the other side of the head can be used as an input signal. Furthermore, a signal EQ from an external source can be used as an input signal. Thus, for example, a signal of a stereo system can be connected to the hearing device via an audio shoe. The emission of signals by the processing unit 3 is optionally carried out separately for interfering and useful signals.

In the example shown in FIG. 2, a directional microphone or BSS unit 7 is connected downstream of the signal processing unit 3. A desired number of directional microphones or directional microphone settings will possibly be provided by this means. A separation of the signals is optionally carried out here by means of blind source separation (BSS). The directional microphone or BSS unit 7 can also be arranged between the microphones 2 and the signal processing unit 3. The microphone signals or the signals of the external sources and signals of the other side are then fed into the directional microphone unit. A directional microphone/BSS processing is not, however, a mandatory requirement for the present invention, so that a corresponding processing unit can optionally be dispensed with.

In the example shown in FIG. 2, a processing block 8 for spatial processing is connected downstream of the BSS unit 7. This block can also have numerous other functions besides FIR filtering, as will be explained in detail with the aid of FIG. 5. The aim in each case is to influence interaural cross correlation, possibly the interaural time difference for direction perception or suitable frequency response profiling. The processing of the signals in this block 8 is always carried out such that associated left-side and right-side signals are altered in their spatial impression.

The output signals of the block 8 for spatial processing are mixed with appropriate weightings in a subsequent mixing unit 9. Both the mixing and the spatial processing are controlled by the control or signal processing unit 3 or its classifier 6. The output signal of the mixing unit 9 is fed to the loudspeaker or earphone 4.

It is additionally pointed out that the use of a control unit 3, as is provided in the example shown in FIG. 2, is not mandatory. The parameters for the mixing and the spatial processing are then fixed. Furthermore, a very simple embodiment can also consist in just one signal from the left side and the right side respectively being processed and the mixing being dispensed with.

For example, it may be beneficial to effect an increase in distance depending on the signal type. According to the invention, this can be done successfully in a hearing device for example by means of the layout reproduced schematically in FIG. 2. At the signal input, the hearing device has a microphone 10. A signal processing unit 11 which has a classifier 12 is connected downstream thereof. The signal processing unit 11 serves also in providing the usual amplification. The output signal of the signal processing unit 11 is branched to two filters or directional microphones 13, 14. Furthermore, provision is made in the one branch for an FIR (finite impulse response) filter 15 having a constant amplitude response (allpass). It provides a defined phase shift of the signal. The signals of the two branches are mixed in a mixer 16 and fed to a loudspeaker 17. The classifier 12 influences the phase shift of the FIR filter 15 and/or the mixing ratio in the mixer 16.

The FIR filter 15 is shown in a specific embodiment in FIG. 4. A digital input signal ES is multiplied in fixed time-delay stages (z⁻¹) with different coefficients K1, K2, K3 and K4. The sum of the individual signals leads to an output signal AS. Depending on the choice of coefficient, a corresponding phase or time shift of the signal is produced. If the shift of the signal in the left ear is different from that in the right, this results in a different spaciousness perception. The perception, for example, of direction and/or distance can be influenced.

It will be shown below with reference to several examples how, spatial reproduction can be improved depending on certain parameters of the hearing apparatus or hearing device. To this end, the corresponding parameter will be presented, and it will in each case be indicated how spatial reproduction can be altered by altering one of the aforementioned target variables:

1. Classification of the input signal
a) Adjustment of methods by means of a classifier
   i) Increase of distance depending on the signal type (e.g. music or speech); it can be achieved with the aid of the layout shown in FIG. 2, as already outlined above.
   ii) Increase of stereo width depending on the signal type (e.g. music or speech); it can be achieved in the case of binaural supply by appropriately different shifting of the left and right signals.
   iii) Admixing of reverberation depending on class; mixing and controlling with the aid of the classifier can be carried out in an analogous manner to the principle shown in FIG. 2.
b) Reverberation dependence (determination with the classifier or another suitable analyzing unit)
   i) Increase of distance depending on the degree of fading of the signal (e.g. if the signal is fading, the resulting distance increase will be lower);
   ii) Increase of stereo width depending on the degree of fading of the signal (e.g. if the signal is fading, the resulting increase of stereo width will be lower);
   iii) Admixing of reverberation depending on the proportion of reverberation detected in the signal
c) Virtual auditory display
   i) Class-dependent shifting of a signal in a spatial direction (e.g. shifting of an interfering noise to the back);
   ii) Any combination of method 1.c.i with one or more methods from 1.a and/or 1.b

2. Directional microphone or separated signals
a) Directional filtering by means of a directional microphone and subsequent changing of the source distance depending on direction instead of pure suppression (several directional characteristics would have to be computed in parallel).
b) Changing of the source distance of signals which have been obtained with the aid of a blind source separation (BSS) algorithm, possibly depending on the source direction and/or distance.
c) Combination of methods from 2.a and/or 2.b with one or more of the methods from 1.

3. Externally fed signals
Besides the microphone signal(s), other signals can also be introduced, for example electromagnetically, into the hearing apparatus/the hearing device. Differential treatment of the microphone signals and of the electrically fed signals can lead to an improvement in spatial reproduction. Thus, for example, the microphone signals could, where an externally fed signal (telephone, stereo system, FM system etc.) is present, be faded further away or to the back.

4. Interference proportion of noise removal
Instead of suppressing the interference proportion, it can be mixed back into the signal at an adjustable distance or direction. This can also be done using a similar circuit layout to that represented in FIG. 2.

5. Level dependence
According to a further additional or alternative option, the strength of the effectiveness of the methods is adjusted depending on the signal level. This can be achieved in a simple manner by means of a corresponding level meter, which is usually present in any case.

6. User control

According to a further option, provision can be made for the user to control the effectiveness of the algorithms manually, for example with the aid of a remote control. In this way, manual or semi-automatic control would be possible.

7. Binaural methods
The parameters of the methods are adjusted after an analysis of the signals for the right and the left ear. A wireless coupling of hearing devices is required for this purpose, for example.

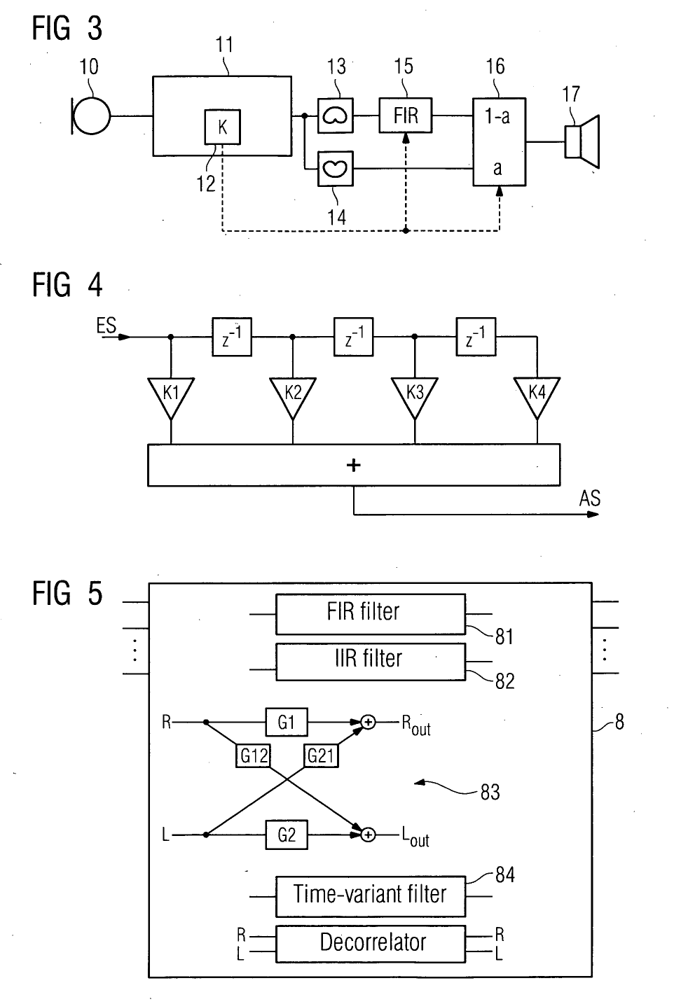

The processing block 8 for the spatial processing (cf. FIG. 2) can be implemented in different ways in accordance with the example shown in FIG. 5. For example, this block can have one or more of the following elements:
a) an FIR (finite impulse response) filter 81, as in the example in FIG. 3 and 4;
b) an IIR (infinite impulse response) filter 82 which is fashioned recursively;
c) a cross-element structure 83, by means of which, through crosswise linking with weightings G1, G2, G12 and G21, two signals R, L become output signals Rₒᵤₜ and Lₒᵤₜ;
d) a time-variant filter 84, by means of which a time-shifting of the signal is effected and
e) a stochastic decorrelator 85 for separating interfering noises.

The inventive methods presented above for improving spatial perceptibility and the corresponding hearing apparatuses/hearing devices thus result, for example, in improved sound perception. Music may sound more lively, for example. In particular, the brain is helped by the deliberately controlled differential localization of sources to be better able to separate the “competing” sources.

1.-13. (canceled)

14. A method for the binaural supply of a human hearing with the aid of a binaural hearing apparatus, comprising:
receiving an input signal of the hearing apparatus;
processing of the input signal into an output signal that leads to spatial perception; and
controlling of at least one variable of the output signal, based upon the input signal, of the hearing apparatus such that spatial perception is altered.

15. The method as claimed in claim 14, wherein the input signal is analyzed, and the controlling is effected in accordance with the result of the analysis.

16. The method as claimed in claim 15, wherein the analyzing comprises a separation of sound sources, and the controlling is effected in accordance with the separated sound sources.

17. The method as claimed in claim 15, wherein the separation is effected via least a directional microphone or a blind source separation algorithm.

18. The method as claimed in claim 15, wherein the analyzing comprises a determining of a fading of the input signal, and the controlling is effected in accordance with the fading.

19. The method as claimed in claim 18, wherein the analyzing comprises a separation of sound sources, and the controlling is effected in accordance with the separated sound sources.

20. The method as claimed in claim 19, wherein the separation is effected via least a directional microphone or a blind source separation algorithm.

21. The method as claimed in claim 15, wherein the analyzing comprises a detection of interfering noise, and the controlling is effected in accordance with the proportion of interfering noise.

22. The method as claimed in claim 15, wherein during analysis, a signal class or a level of the input signal is determined, and the controlling is effected depending on the classification or the level determined.

23. The method as claimed in claim 14, further comprises receiving at least one externally fed signal, and the controlling is effected in accordance with the externally fed signal.

24. The method as claimed in claim 14, wherein the variable influencing spatial perception is at least one perception selected from the group consisting of distance of a source from the hearing apparatus, spatial direction of a source in relation to a predetermined zero-degree direction of the hearing apparatus, source location and a characteristic of the spatial reverberation.

25. A hearing apparatus for the binaural supply of a human hearing, comprising:
a pick-up device for picking up an input signal of the hearing apparatus;
a processing device for generating an output signal, based on the input signal, which leads to a spatial perception; and
a controller for controlling the processing device with regard to at least one variable of the output signal of the hearing apparatus such that spatial perception is altered.

26. The hearing apparatus as claimed in claim 25, wherein the processing device comprises a classifier, wherein the classification result is fed to the controller for controlling.

27. The hearing apparatus as claimed in claim 25, wherein the processing device has a directional microphone and/or a blind source separator for separating sources.

28. The hearing apparatus as claimed in claim 25, wherein the hearing apparatus has a plurality of input channels and the controller are controllable based on the signal strength of one or more of the input channels.
